(19) United States
(12) Patent Application Publication
(10) Pub. No.: US 2006/0079187 A1
(43) Pub. Date: Apr. 13, 2006

(54) GPS, infrasonics, audio tools armband for location and assistance in response to astronomical and other crises

(76) Inventor: James Timothy Struck, Chicago, IL (US)

Correspondence Address: JAMES T. STRUCK, APT. 206, 2000 W. MORSE AVE, CHICAGO, IL, 60645, US

(21) Appl. No.: 11/224,731

(22) Filed: Sep. 12, 2005

Related U.S. Application Data
(60) Provisional application No. 60/615,755, filed on Oct. 3, 2004.

(51) Int. Cl. H04B 1/38

(52) U.S. Cl. 455/90.2; 455/556.1

(57) ABSTRACT

Astronomical crises come in the form of galactic collisions, stellar collisions, collisions with asteroids, solar storms and collisions of many other types. There also can be increases in ultraviolet, microwave, gamma, or infrared radiation. This device and method is somewhat different in that it is a way to locate people or books when the GPS system or other location systems are damaged or down. Audio tapes of the person's name or name of the book, a cell phone to provide communication with someone else or provide psychotherapy, and an infrasonic transmitter, to emit radiation when one does not want to make noise, accompany the GPS device if the GPS transmitter or receiver fails. An armband provides the support and housing for these devices to assist with location. The armband could also be used to locate books with an electromagnetic wave trigger mechanism and a timer trigger mechanism.

Note—I am not particularly interested in prohibiting other people from using this invention. Rather, I am trying to imitate people like Edison, Morse, Tesla, Singer, Polaroid and other inventors by seeing if I can get some claim(s) approved and get USPTO and other credit (citation or some kind of donation) for the invention. I do not want someone to see the claims or drawings and decide that they cannot use the ideas or invention. Of course, if this invention ignorantly infringes on other inventions, the invention should not be used freely as others' rights are involved.

### BRIEF DESCRIPTION OF SEVERAL VERSIONS OF THE DRAWINGS MORE SPECIFICATIONS

FIG. 1-A depicts the armband with four pockets. The pockets can be structured to be closed or open. Closed pockets would make the four location and assistance devices harder to loose. Reference Numeral 1 points to the GPS receiver or transmitter. GPS receivers can be obtained from sources like Motorola and other corporations. This GPS receiver is just to receive GPS satellite signals and give a location. Reference numeral 2 is the infrasonic transmitter. There are other frequencies that can be used, but infrasonic transmission offers the benefit of not being as easy to detect as audible frequencies. Reference Numeral 3 is an audio tape player. This is for recording messages. Again, this is primarily a method invention; a method to respond to astronomical collisions that knock out in some way the GPS satellite system. These other tools are methods to detect people or astronauts when that happens. Reference numeral 4 is the cell phone type of device. FIG. 1-B shows the view from above or looking down onto the armband in the direction of fingers when the armband is on the person's arm. Reference numeral 5 is pointing to the pockets.

Because there is discussion of the risk of cancer being caused by cell phones, FIG. 7 refers to the radiation shield dental material type of shield on the underside of the armband. The dental radiation shield type of material is optional for those who want to decrease possible cancer risk.

FIG. 2 shows the armband on the arm of a person. After the initial patent application was sent in, I noticed several people with armbands and tape players. I was not aware of these types of products when the initial patent application was applied for. This type of audio tool in an armband is clearly already claimed or used. My emphasis is on the new use of this for responding to astronomical and other GPS destabilizing crises. Reference numeral 15 points to the arm of a person; there is no claim in any way to ownership of the arm. The arm is there to show where the device can be used. The reference numerals point to the same items of FIG. 1. 1 points to the GPS device, 2 points to the infrasonic transmitter, 3 points to the audio tool, 4 points to the cell phone device.

FIG. 3 shows the armband on a book. The use of all of these tools on a book would be wasteful. The cell phone and infrasonic device can be removed to save resources. The device would only contain the GPS device and the audio player. Reference numeral 14 points to the back side of the armband on a book; that is the location and assistance devices are on the other side. Reference numeral 3 points to the audio tool for playing the title of the book, author or other information. Reference numeral 1 points the GPS receiver.

FIG. 4 depicts the armband with reference numeral 7 pointing to timer on the book. The timer sets off the audio tape player on the date due. Reference numeral 3 points to the audio tape player. Reference numeral 1 points to the GPS receiver. This is again a method to find books when GPS systems go down. Clearly, radio frequency detection (RFID) is already talked about or used by libraries. I did not know about this technology before the patent application was submitted, besides its use in patent application U.S. Pat. No. 6,900,731. The patent talked about in the prior art section used alpha numeric codes not audio tapes of the book's information.

FIG. 5-A shows the armband with tape player and GPS device. An oscillating wave is used to cause vibration in the audio tape device. Einstein's photoelectric effect shows that photons release electrons. If each book is set for a certain frequency (Reference Numeral 10) of an electromagnetic wave then each book could independently receive the electromagnetic wave and trigger the release of an electron. The release of an electron could trigger the audio tape. This would border on not being useful because of the perceived difficulty of finding a unique electromagnetic wave for each book, but that is the basic physics I have some grasp of.

FIG. 5-B shows the structure of the electromagnetic trigger and receiver mechanism. A certain slit structure could receive a signal from a transmitter with a certain signal. Slit structures could be manipulated to be distinct for each book. This could be used for location of people as well.

FIG. 6 shows the armband with the basic pockets without the devices. This armband could actually serve as a collection device for the astronomical events pictured in the drawing. Again, as other inventions claim to be armbands with several pockets, this is discussing a collection device for various astronomical events.

FIG. 7 shows one possible design of the armband structure. A document deposit filed by me and received by the USPTO on Nov. 5, 2004 (Disclosure Document Number 565011) is no longer eligible for a patent, but the point is to use a dental radiation shield type of device to protect the body or arm from the radiation of the cell phone. This is to limit cancer possibilities. Reference numeral 9 points to the dental x-ray radiation shield type of material. This is a possible type of material and not necessary for all designs of this invention. The reason it is no longer eligible for patent protection is that it was revealed to companies on and after Sep. 27, 2004. Number 14 is the armband, number 11 is the top pocket and number 12 is the bottom pocket.

FIG. 8 shows the Front Page drawing of the application. This depicts the four devices and the interaction with various types of space materials. The invention again only claims the method in responding to GPS problems, but it could also be used to capture space particles.

The drawings and claims do not discuss the warnings. Still, warnings about excessive use of certain materials possibly damaging drills or other animals, the possible misuse of the product to stalk people, and not using the product to waste emergency services' time could easily be used and learned from.

FIG. 9 shows the method, flowchart and steps for using the device to help with psychotherapy issues during astronomical collisions and breakdown of the GPS system. The GPS system goes down, the cell phone is used to call for psychotherapy and psychological assistance, the audio tape and infrasonic device are used to help with location. Inventions with fewer variables might claim infringement versus my invention here, but these variables could uniquely, in an additional way, assist with events like asteroid strikes against the GPS satellite system. GPS could also still help with location during psychotherapy. As discussed in the application, other patent applications or patents do not include both the words GPS and psychotherapy. Similar words besides psychotherapy (for example, psychological counseling, counseling, therapy) might be in other inventions. Certainly, many cell phones like Sprint's include a cell phone with GPS capabilities. My invention has the GPS device separate from the cell phone. This is a different design and a different invention.

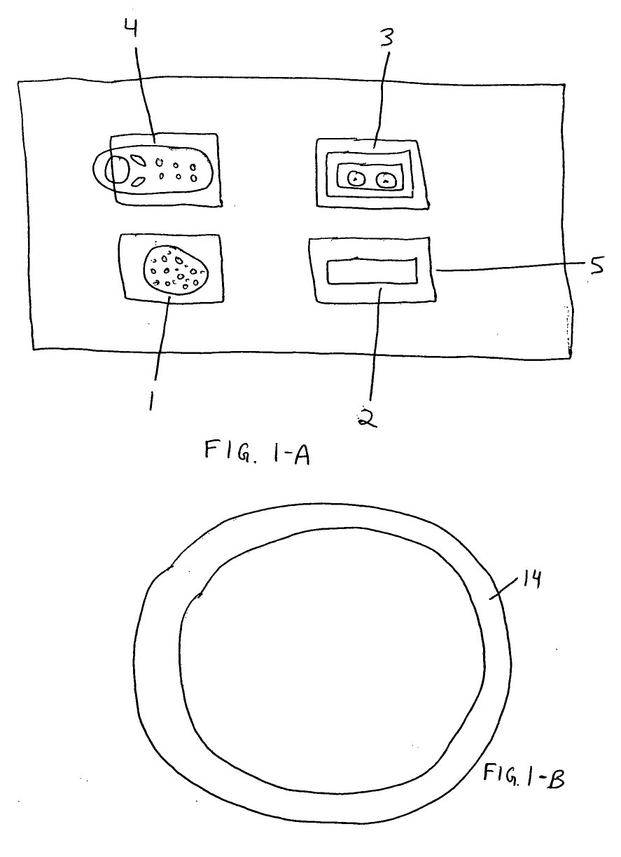

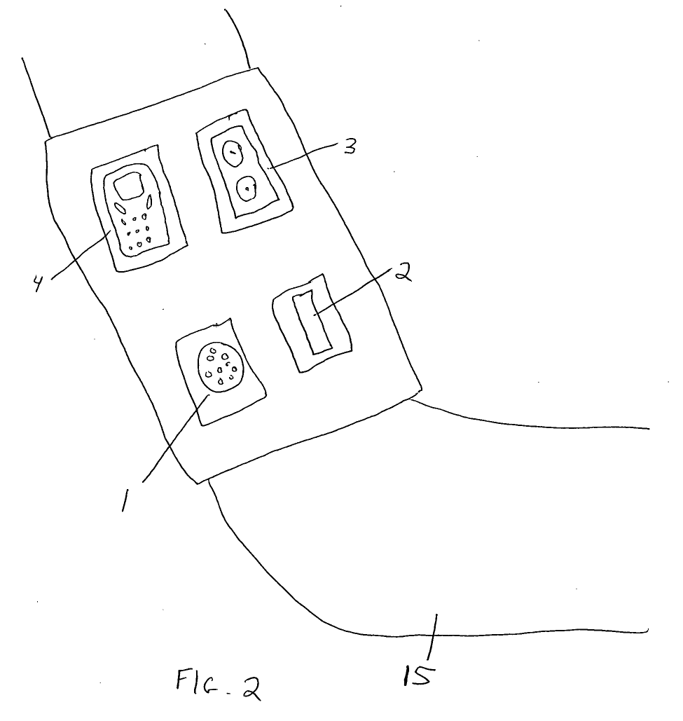

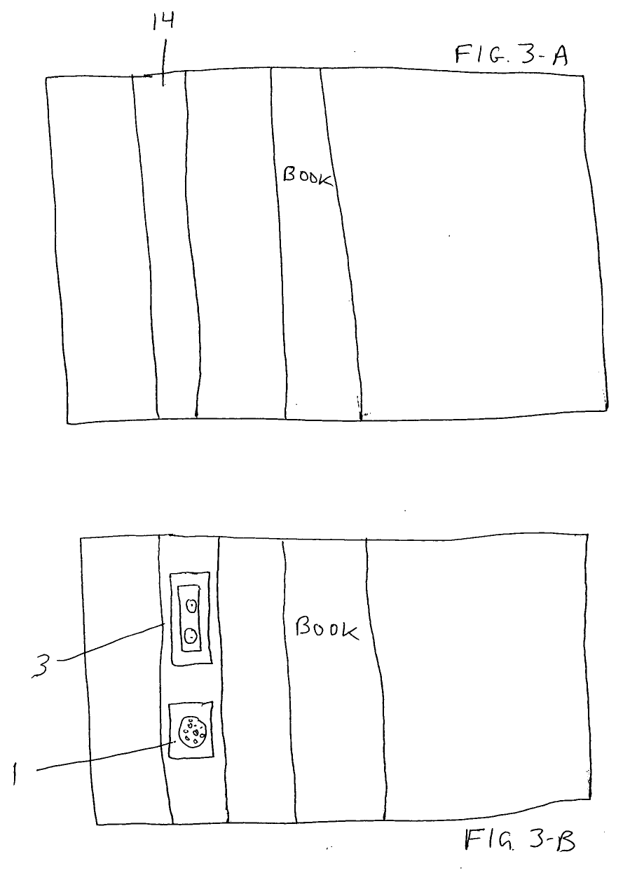

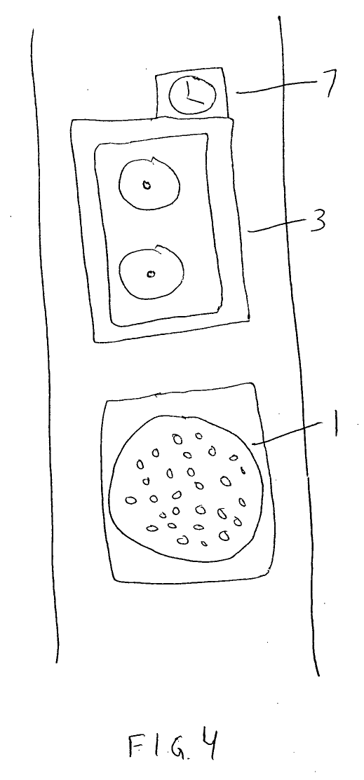

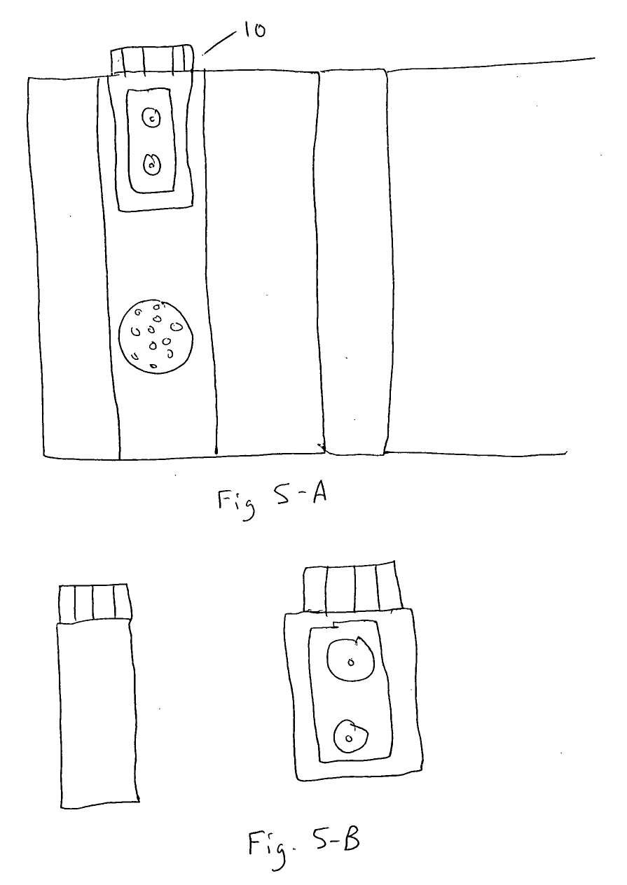

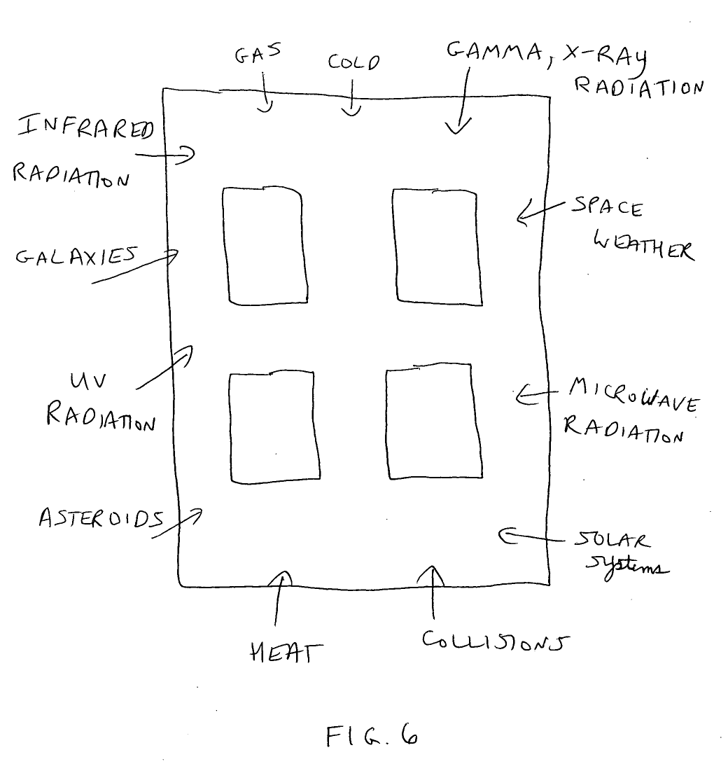

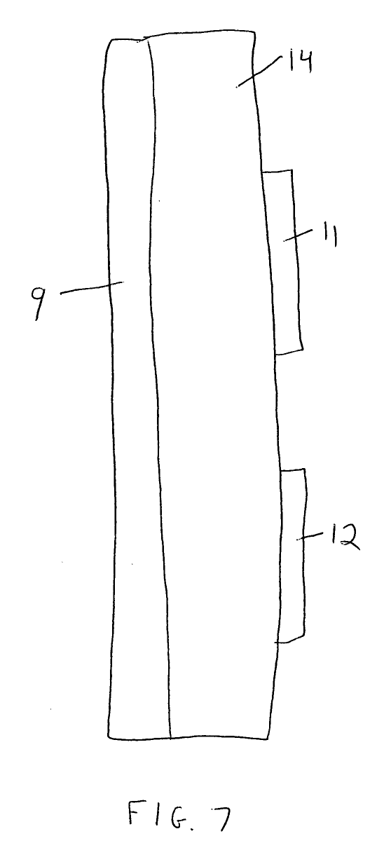

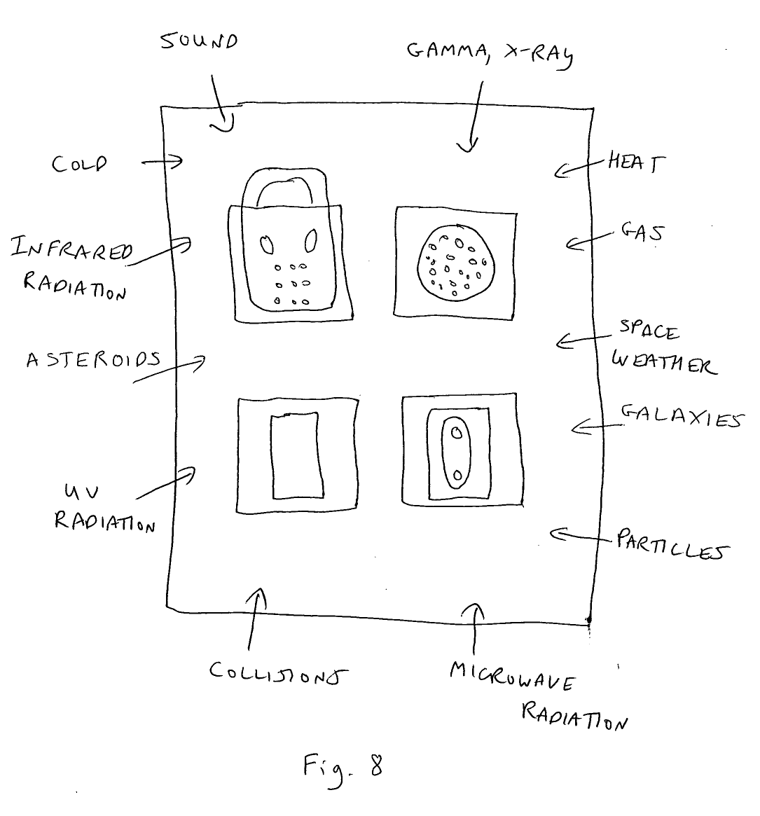

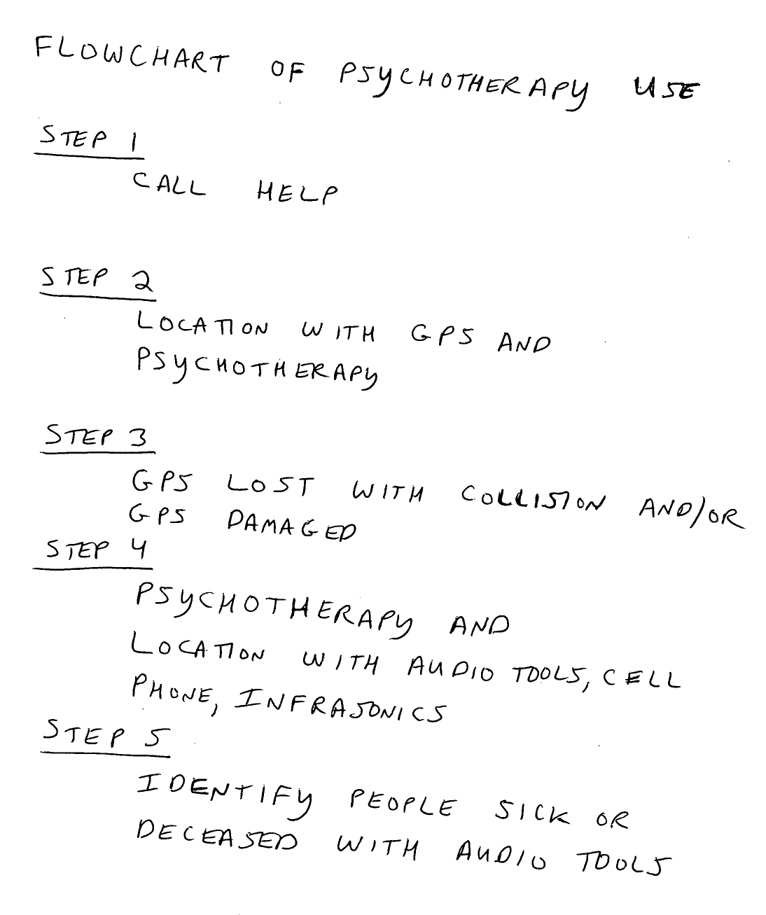

### DRAWINGS-REFERENCE NUMERALS

9 Dental x-ray radiation shield type of material
1 points to the GPS device
2 points to the infrasonic transmitter
3 points to the audio tool
4 points to the cell phone device
7 Timer with due date setting to trigger audio tape
10 Certain frequency trigger for each book
14 arm band
11 pocket on one side above
12 pocket on one side below
15 arm of creature

1. A method for responding to severe space weather, solar storm events, galactic, stellar, unique radiation events or factors which might destabilize the GPS satellite system comprising
(a) Using an armband to hold the items below
(b) Using a GPS receiver, when GPS systems are working or appropriate
(c) Using an infrasonic tape player or transmitter, when no noise is wanted
(d) Using an audio tape player for playing a tape of the person's name or identification for situations like loss of consciousness or loss of the person or animal
(e) Providing a mobile telephone to communicate about the space weather situation

2. An armband comprising
(a) a GPS receiver
(b) an infrasonic tape player or transmitter
(c) an audio tape player
(d) a mobile telephone
(e) pockets for these devices

3. A method of assisting with the location of library books comprising
(a) Placing an elastic band over the front cover or back cover of books
(b) Recording an audio tape or infrasonic recording of the name, author, publication year and copy number of a book which can be triggered to play when a signal is sent from a transmitter
(c) Triggering the tape to play on the day after the book is supposed to be due.

4. A method to assist with psychotherapy in patients comprising
(a) Talking on a cell phone to talk to a psychotherapist
(b) Using a GPS receiver to assist with location
(c) Providing an audio tape to play the person's name back if the person is confused or lost
(d) Providing an infrasonic device to transmit information if the person is lost

5. A method of warning users of this product about unlawful or illegal use comprising the following steps
(a) Labelling the outside of the box and/or in the box which warns that the product should not be used illegally to follow people around, waste police time, and may hurt animals like drills or other primates when produced
(b) Providing a statement in several places in box to read the warning label.
(c) Providing these warnings to alter the use of the product and improve the use of the product.
